(19) United States
(12) Patent Application Publication
(10) Pub. No.: US 2002/0024401 A1
(43) Pub. Date: Feb. 28, 2002

(54) Nonreciprocal circuit device and communication apparatus

(75) Inventor: Akihito Masuda, Kanazawa-shi (JP)

Correspondence Address: OSTROLENK FABER GERB & SOFFEN, 1180 AVENUE OF THE AMERICAS, NEW YORK, NY, 100368403

(73) Assignee: Murata Manufacturing Co., Ltd.

(21) Appl. No.: 09/809,585

(22) Filed: Mar. 15, 2001

(30) Foreign Application Priority Data
Mar. 15, 2000 (JP) 2000-072182

(51) Int. Cl. H01P 1/32

(52) U.S. Cl. 333/1.1; 333/24.2

(57) ABSTRACT

The present invention provides a nonreciprocal circuit device including a ferrite which has a high dimensional accuracy, and which is inexpensively producible and adaptable to the miniaturization thereof, and further provides a communication apparatus using this nonreciprocal circuit device. In this nonreciprocal circuit device, a microwave ferrite in a center electrode assembly is formed into a rectangular shape in a plan view by cutting out from a prism-block shaped ferrite sintered matrix having a rectangular cross-section, for every predetermined thickness along a cut line C. When cutting, it is desirable to use an inside cutter, a dicer, or the like. In a cut-out ferrite, the dimensional tolerance of each portion thereof is within ±0.05 mm, and the angles θ's formed by adjacent side surfaces thereof are 90±1°.

### BACKGROUND OF THE INVENTION

1. Field of the Invention

The present invention relates to a nonreciprocal circuit device, and more particularly, to a nonreciprocal circuit device such as an isolator or a circulator used in a microwave band. The present invention further relates to a communication apparatus using this nonreciprocal circuit device.

2. Description of the Related Art

Generally, a lumped-constant type isolator adopted into mobile communication equipment such as portable telephones has the function of passing signals only in the transmission direction and blocking the transmission thereof in the opposite direction. In recent years, mobile communication equipment is in an increasing demand for cost reduction, as well as that for the reduction in size and weight, because of its use. Correspondingly, the isolator is also required to be reduced in size, weight, and cost.

As such a lumped-constant type isolator, the isolator has been proposed which has a structure described below. A resinous terminal case is disposed on a lower yoke portion formed of a magnetic metal, and accommodates a center electrode assembly and matching capacitors. An upper yoke portion formed of a magnetic metal is placed on the lower yoke portion. The center electrode assembly is formed by disposing a plurality of center electrodes on a microwave ferrite. A permanent magnet is stuck on the inner surface of the upper yoke portion, and applies a DC magnetic field to the center electrode assembly.

Hitherto, as a microwave ferrite in the center electrode assembly, a disk-shaped one has been used. The microwave ferrites have been produced piece by piece by press-molding using a mold and then firing at a predetermined temperature.

However, there are variations in the ferrite material and the firing temperature among ferrites, so that the ferrites vary in the shrinkage factor among them, when they are fired. Thereby, a problem that the dimensional accuracy thereof after firing becomes unstable, occurs. This affects the yield of microwave ferrites, resulting in an increase in the production cost thereof. In addition, there is another problem that, when press-molding microwave ferrites piece by piece using a mold, it is difficult to meet the demand for the miniaturization thereof.

### SUMMARY OF THE INVENTION

Accordingly, it is an object of the present invention to provide a nonreciprocal circuit device having a ferrite which has a high dimensional accuracy, and which is inexpensively producible and adaptable to the miniaturization thereof, and further to provide a communication apparatus using this nonreciprocal circuit device.

In order to achieve the above-described object, the nonreciprocal circuit device in accordance with the present invention comprises: a permanent magnet, a ferrite to which a DC magnetic field is applied by the permanent magnet, the ferrite including a plurality of center electrodes, a yoke which accommodates the permanent magnet, the ferrite, and the center electrodes, and the ferrite being formed by cutting out from a block-shaped ferrite sintered matrix so that the first and second main surfaces thereof which are opposed to each other, are defined as at least cut surfaces.

By cutting out a ferrite having a desired shape from a block-shaped ferrite sintered matrix, a ferrite having a high dimensional accuracy can be obtained without the need to consider variations in the shrinkage factor among ferrites when they are fired.

By forming the ferrite as a rectangle in a plan view, the ferrite can be the most effectively cut out from the ferrite sintered matrix. Also, by setting the tolerance of the angles defined by adjacent side surfaces of the ferrite to be within ±1°, the mutual cross angles between the center electrodes are stabilized, and thereby the electrical characteristics of the nonreciprocal circuit device can be also stabilized. Alternatively, by setting the dimensional tolerance of the ferrite to be within ±0.05 mm, the frequency characteristics of the nonreciprocal circuit device can be stabilized.

Moreover, by arranging each of the first and second main surfaces which are the cut surfaces of the ferrite so as to have a surface roughness not more than Ra (center line surface roughness)=0.9, the surface roughness of each of the first and second main surfaces becomes small, so that the adhesion between the first and second main surface and the center electrodes is improved, respectively, thereby suppressing the insertion loss of the nonreciprocal circuit device.

A communication apparatus in accordance with the present invention can achieve superior frequency characteristics, by comprising the nonreciprocal circuit device having the above-described features.

The above and other objects, features, and advantages of the present invention will be clear from the following detailed description of the preferred embodiments of the invention in conjunction with the accompanying drawings.

### BRIEF DESCRIPTION OF THE DRAWINGS

FIG. 1 is an exploded perspective view showing a nonreciprocal circuit device in accordance with a first embodiment of the present invention;

FIG. 2 is an external perspective view of the nonreciprocal circuit device shown in FIG. 1;

FIG. 3 is an electrical equivalent circuit diagram for the nonreciprocal circuit device shown in FIG. 1;

FIG. 4 is a perspective view for explaining the ferrite in the nonreciprocal circuit device shown in FIG. 1;

FIG. 5 is another perspective view for explaining the ferrite in the nonreciprocal circuit device shown in FIG. 1;

FIG. 6 is a still another perspective view for explaining the ferrite in the nonreciprocal circuit device shown in FIG. 1;

FIG. 7 is a block diagram showing an embodiment of a communication apparatus in accordance with the present invention;

FIG. 8 is a perspective view for explaining another ferrite; and

FIG. 9 is a perspective view for explaining a still another ferrite.

### DESCRIPTION OF THE PREFERRED EMBODIMENTS

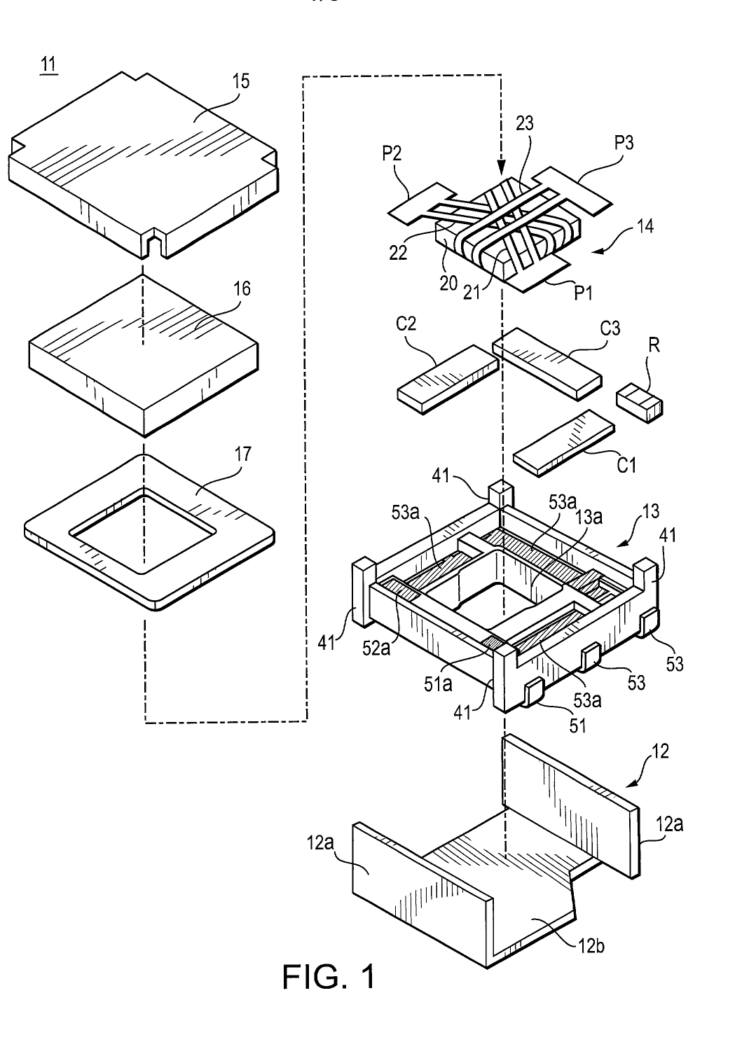

First Embodiment, FIGS. 1 through 6

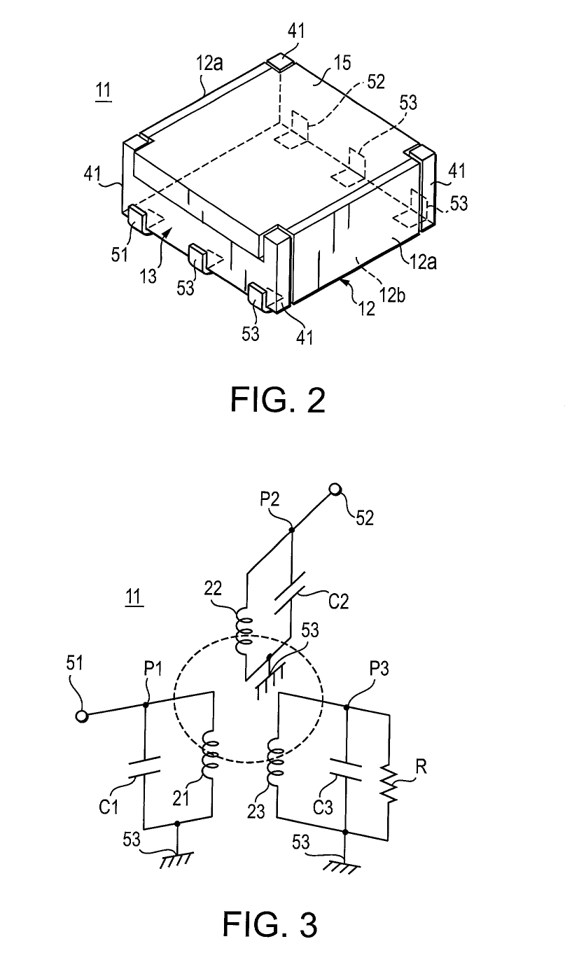

FIG. 1 is an exploded perspective view showing the construction of a nonreciprocal circuit device in accordance with an embodiment of the present invention, and FIG. 2 is a perspective view showing the appearance thereof. This nonreciprocal circuit device is a lumped-constant type isolator. As shown in FIG. 1, the lumped-constant type isolator 11 comprises a lower yoke portion 12, a resinous terminal case 43, a center electrode assembly 14, an upper yoke portion 15, a permanent magnet 16, and an insulative spacer 17.

The lower yoke portion 12 is formed of a magnetic metal, and has left and right side walls 12a and bottom wall 12b. The resinous terminal case 13 is disposed on the lower yoke portion 12, and accommodates the center electrode assembly 14. The upper yoke portion 15 formed of a magnetic metal is placed on the lower yoke portion 12. The permanent magnet 16 is stuck on the bottom surface of the upper yoke portion 15, and applies a DC magnetic field to the center electrode assembly 14. The lower and upper yoke portions 12 and 15 form a magnetic circuit. The yoke portions 12 and 15 are formed by stamping a plate material constituted of a high-permeability material such as iron or silicon steel, and by plating the surface of the stamped plate material with copper or silver after bending.

As shown in FIG. 2, input/output terminals 51 and 52, and ground terminals 53 are insert-molded to the resinous terminal case 13. The input/output terminals 51 and 52 form input/output connection electrode portions 51a and 52a, respectively, by exposing one side ends thereof to the outside walls of the case 13, and by exposing the other ends thereof to the inside surfaces of the case 13. Likewise, the ground terminals 53 form ground connection electrode portions 53a, by exposing four ends thereof to the opposed outside walls of the case 13 and by exposing the remaining ends to the inside surface. In addition, poles 41 are each provided at the four corners of the resinous terminal case 13. As a material of the terminal case 13, a highly heat-resistant resin such as a liquid polymer is used.

In the center electrode assembly 14, three center electrodes 21 through 23 are disposed on the top surface (this is a first main surface and is one magnetic pole surface) of a microwave ferrite 20 so as to intersect one another at an angle of substantially 120°, in a mutually insulated state, for example, by interposing therebetween an insulative tape constituted of a highly heat-resistant material such as polyimide resin. In these center electrodes 21 through 23, port portions P1 through P3 on one end sides thereof are led out horizontally. The center electrodes 21 through 23a has a common shield portion on the other end side thereof, which is abutted against the bottom surface (this is a second main surface and is the other magnetic pole surface) of the ferrite 20. This common shield portion covers substantially the entire bottom surface of the ferrite 20, and is connected, by a method such as soldering, to the bottom wall 12b of the metallic lower yoke 12 through a window 43a of the terminal case 13 for grounding.

In matching capacitors C1 through C3 (matching capacitors which have dielectric constants εᵣ of 9 to 200 and thickness of 0.1 to 0.3 mm, are used depending on the operating frequency of the isolator 11), the hot-side capacitor electrodes thereof are soldered to the port portions P1 through P3, respectively, while the cold-side capacitor electrodes thereof are each soldered to the ground connection electrode portions 53a which are exposed to the inside surface of the terminal case 13. One end of a terminating resistor R is connected to the hot-side capacitor electrode of the matching capacitor C3, and the other end thereof is connected to the ground connection electrode portion 53a. That is, the matching capacitor C3 and the terminating resistor R are connected in parallel between the port portion P3 of the center electrode 23 and the ground. FIG. 3 shows the electrical equivalent circuit for the isolator 11.

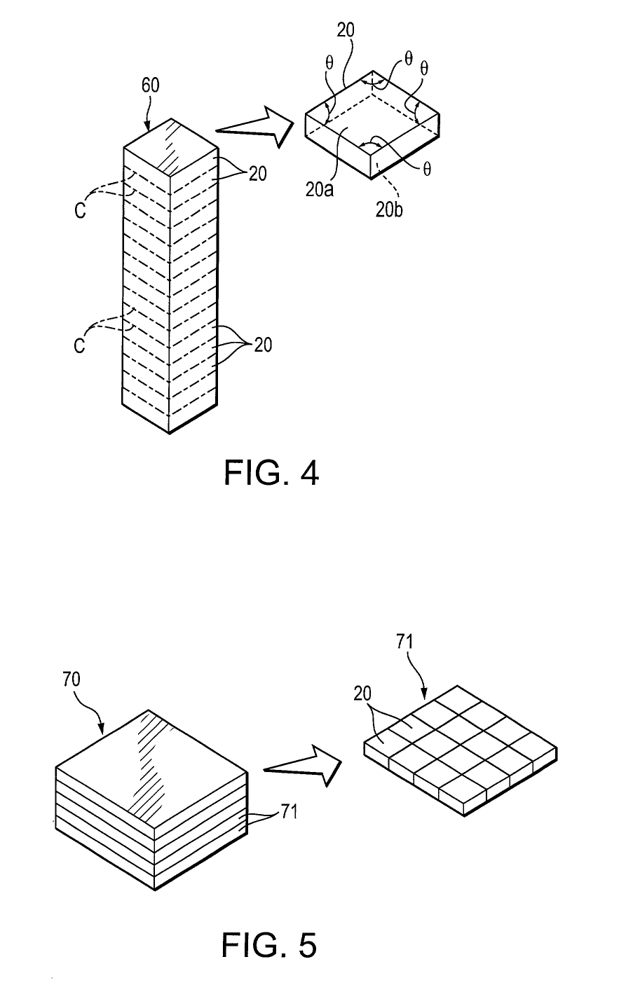

Here, the microwave ferrite 20 in the center electrode assembly 14 is one which has a rectangular shape in a plan view, and which is, for example, as shown in FIG. 4, formed by cutting out a ferrite 20 from a prism-block shaped ferrite sintered matrix 60 having a rectangular cross section, for every predetermined thickness along a cut line C. Since numerous ferrites can be cut out from a single ferrite sintered matrix 60 in this way, the unit price of each individual ferrite 20 can be reduced. As a cutting method in this case, it is desirable to use an inside cutter, a dicer, or the like. The inside cutter causes less shake of the blade thereof during cutting than an outside cutter, so that the inside cutter can improve the dimensional accuracy of the ferrite 20 and suppress the occurrence of burrs. More specifically, when performing cutting using an outside cutter, the cutting tolerance is within about ±0.05 to ±0.1 mm, whereas when performing cutting using an inside cutter, the cutting tolerance can be improved up to ±0.01 mm. Also, the dicer is a widespread cutter which has a high general versatility, since the dicer has a high working accuracy (tolerance: within ±0.01 mm or below), and is capable of cutting a material at an arbitrary angle.

The thickness of the ferrite 20 is set, for example, to be 0.5 mm or below. Since the ferrite 20 having a desired shape is thus cut out from the ferrite sintered matrix 60, a ferrite 20 having a high dimensional accuracy can be obtained without the need to consider variations in the shrinkage factor among ferrites when they are fired. Particularly, as shown in FIG. 4, by cutting out the ferrite 20 from the ferrite sintered matrix 60 which has a prism block shape for every predetermined thickness, the dimensional accuracy in the thicknesswise direction of the ferrite 20 can be improved, for example, up to the tolerance within ±0.05 mm.

Furthermore, since the ferrite sintered matrix 60 is not required to have a high dimensional accuracy, the yield of the matrixes 60 when they are formed is high. With its redundant portion cut off, the matrix 60 after sintering is formed into a prism block in which the angle tolerance of the ridge portions of the side surfaces thereof is within ±1°, and in which the dimensional tolerance in the longitudinal and transverse directions is within ±0.05 mm. Hence, in the ferrite 20 cut out from the ferrite sintered matrix 60, the dimensional tolerance of each portion thereof is within ±0.05 mm, and the angles θ's formed by adjacent side surfaces are 90±1°. Since the dimensional tolerance of each portion of the ferrite 20 is within ±0.05 mm, the inductance value which the center electrode assembly 14 possesses does not vary, thereby stabilizing the frequency characteristics of the isolator 11. Meanwhile, as the size of the isolator becomes smaller, it is necessary to reduce the fitting clearance of the ferrite 20 (center electrode assembly 14) with respect to the window 13a of the terminal case 13. Therefore, when the ferrite 20 has a dimensional tolerance within ±0.05 mm, it is adaptable to the isolator 11 having a size of 7 mm square or below.

In the center electrode assembly 14, the center electrodes 21 through 23 are folded so as to wrap the ferrite 20. Here, it is to be noted that, when folding the center electrodes 21 through 23 utilizing the ridges of the ferrite 20, the squareness of the angles θ's formed by adjacent side surfaces of the ferrite 20 influences the crossing angle tolerance of the center electrodes 21 through 23. When the tolerance of the mutual crossing angles among the center electrodes 21 through 23 is reduced within ±2°, the insertion loss can be suppressed within the optimum value+about 0.1 dB. This allows the stabilization of electrical characteristics to be achieved. At this time, the tolerance of the angles θ's formed by adjacent side surfaces of the ferrite 20 is within ±1°, which corresponds to a half of the above-mentioned tolerance of the mutual crossing angles among the center electrodes.

In order to reduce their surface roughness, the first and second main surfaces 20a and 20b, which are the cut surfaces of the ferrite 20, are given a surface treatment such as a polishing treatment so as to make Ra (center line surface roughness)=0.9 or below. The reduction in the surface roughness of the first and second surfaces 20a and 20b of the ferrite 20 improves the adhesion between the center electrodes 21 through 23 and the first main surface 20a, and that between the shield portion common to the center electrodes 21 through 23 and the second main surface 20b, thereby decreasing the insertion loss of the isolator 11. For example, the insertion loss of the isolator 11 in the case where the main surfaces 20a and 20b were polished so as to become substantially Ra=0.7, was lower by about 0.01 dB than that in the case where the main surfaces 20a and 20b were polished so as to become substantially Ra=0.9.

As shown in FIG. 5, the ferrite 20 may be produced by firstly cutting out a board 71 having a large area from a ferrite sintered matrix 70 having a parallelepiped block shape, for every predetermined thickness, and by then cutting out a ferrite 20 from this board 71 for every predetermined size. This facilitates the holding of the board 71 during cutting, and hence simplifies the jigs or tools for holding the board 71, which leads to an reduction in the working cost. Alternatively, the ferrites 20 may be produced by collectively cutting out ferrites 20 from a plurality of boards 71 which have been stacked, for every predetermined size. This reduces the times of cutting, and allows the ferrites 20 to be cut out the most efficiently. Since the ferrite 20 has a rectangular shape in a plan view, useless portions (waste portions) hardly occurs in the ferrite sintered matrix 70 having a parallelepiped block shape. This results in reduced working cost and material cost.

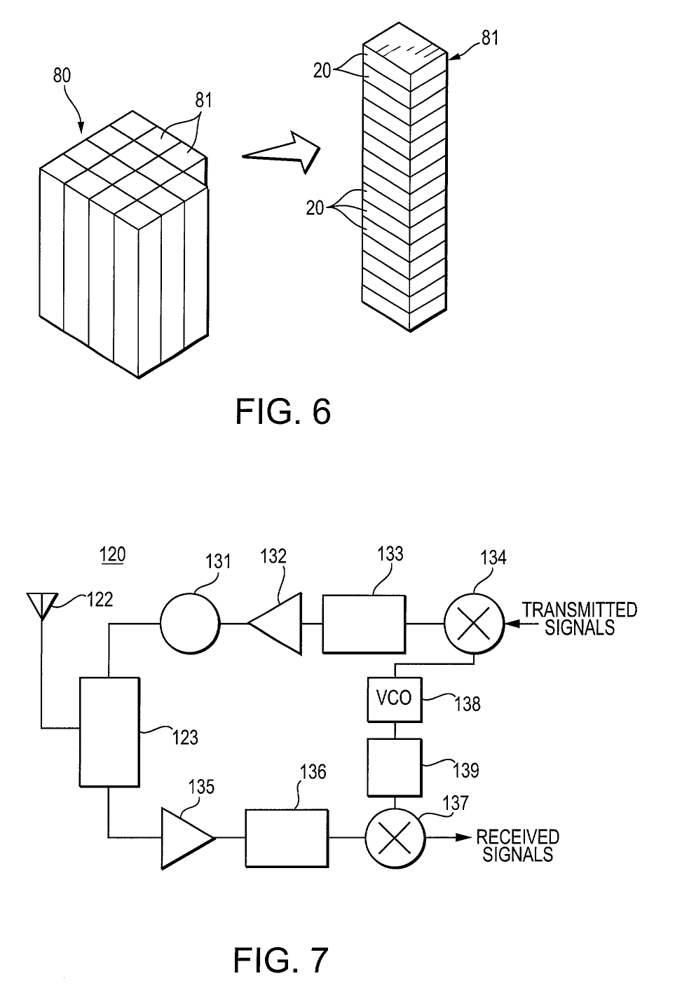

Moreover, as shown in FIG. 6, the ferrite 20 may be produced by firstly cutting out long lengths of prism block 81 from a ferrite sintered matrix 80 having a parallelepiped block shape, for every predetermined size, and by then cutting out a ferrite 20 from this prism block 81 for every predetermined thickness. Thereby, the ferrite 20 can be cut out from a large-sized sintered matrix (5 cm square or above, fore example) with a high dimensional accuracy. Conversely, if such a large-sized sintered matrix is cut out into a board-shape, the parallelism of the work surface thereof will be impaired, so that the dimensional accuracy will not be ensured.

Second Embodiment, FIG. 7

A second embodiment as a communication apparatus in accordance with the present invention will be described taking a portable telephone as an example.

FIG. 7 is a bock diagram showing an electrical circuit in the RF portion of a portable telephone 120. In FIG. 7, reference numeral 122 designates an antenna device, 123 a duplexer, 131 a transmitting-side isolator, 132 a transmitting-side amplifier, 133 a transmitting-side interstage band-pass filter, 134 a transmitting-side mixer, 135 a receiving-side amplifier, 136 a receiving-side interstage band-pass filter, 137 a receiving-side mixer, 138 a voltage-controlled oscillator (VCO), and 139 a local band-pass filter.

Herein, as the transmitting-side isolator 131, a lumped-constant type isolator 11 in accordance with the above-described first embodiment can be used. By mounting this isolator 11, a portable telephone which has a high communication characteristics can be implemented.

Other Embodiments

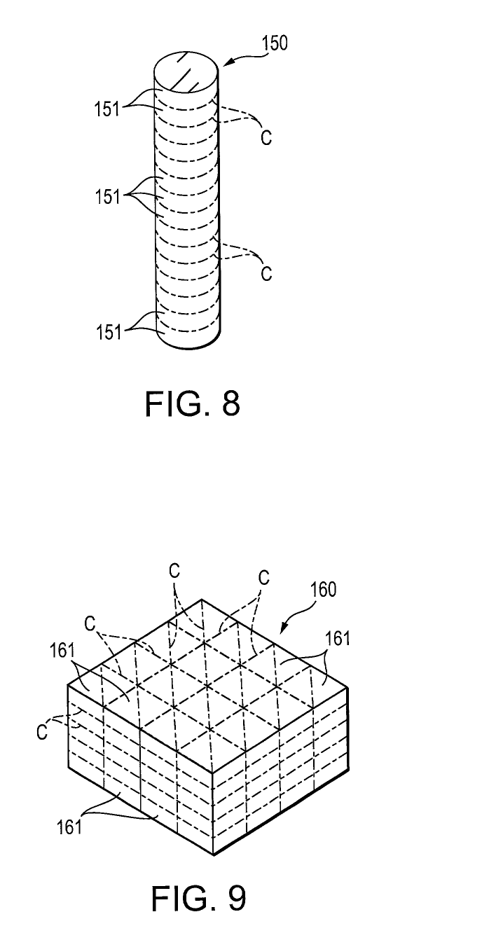

The nonreciprocal circuit device and the communication apparatus in accordance with the present invention are not limited to the above-described embodiments, but may be variously modified. The microwave ferrite in the center electrode assembly does not necessarily require having a rectangular shape. For example, as shown in FIG. 8, the microwave ferrite may be a disk-shaped ferrite 151 which is formed by cutting out from a ferrite sintered matrix 150 having a cylinder block shape along a cut line C, for every predetermined thickness. Alternatively, as shown in FIG. 9, the microwave ferrite may be a triangular ferrite 161 formed by cutting out from a ferrite sintered matrix 160 having a parallelepiped block shape along a cut line C, for every predetermined size.

The present invention can also be applied to nonreciprocal circuit devices which are adopted into other high-frequency components, such as circulators, in addition to isolators.

As is evident from the foregoing, in accordance with the present invention, since a ferrite having a desired shape is cut out from a block-shaped ferrite sintered matrix, a ferrite having a high dimensional accuracy can be obtained without the need to consider variations in the shrinkage factor among ferrites when they are fired. As a result, variations in the characteristics among the nonreciprocal circuit devices can be suppressed, which allows a communication apparatus having superior frequency characteristics to be realized.

While the present invention has been described with reference to what are at present considered to be the preferred embodiments, it is to be understood that various changes and modifications may be made thereto without departing from the invention in its broader aspects and therefore, it is intended that the appended claims cover all such changes and modifications as fall within the true spirit and scope of the invention.

What is claimed is:

1. A nonreciprocal circuit device, comprising:
a permanent magnet;
a ferrite to which a DC magnetic field is applied by said permanent magnet, said ferrite including a plurality of center electrodes;
a yoke which accommodates said permanent magnet, said ferrite, and said center electrodes;
said ferrite being formed by cutting out from a block-shaped ferrite sintered matrix so that the first and second main surfaces thereof which are opposed to each other, are defined as at least cut surfaces.

2. A nonreciprocal circuit device in accordance with claim 1, wherein said ferrite has a rectangular shape in a plan view.

3. A nonreciprocal circuit device in accordance with claim 1 or 2, wherein the tolerance of the angles defined by the adjacent side surfaces of said ferrite is within ±1°.

4. A nonreciprocal circuit device in accordance with claim 1 or 2, wherein the dimensional tolerance of said ferrite is within ±0.05 mm.

5. A nonreciprocal circuit device in accordance with claim 1 or 2, wherein each of the first and second main surfaces which are the cut surfaces of said ferrite are arranged so as to have a surface roughness not more than Ra=0.9.

6. A communication apparatus provided with a nonreciprocal circuit device in accordance with claim 1.
